(19) United States
(12) Patent Application Publication
(10) Pub. No.: US 2020/0079440 A1
(43) Pub. Date: Mar. 12, 2020

(54) UTILITY VEHICLE DECK CORNER APPARATUS, SYSTEM AND METHOD

(71) Applicant: Aluminum Industries Investments Pty Ltd, Brighton (AU)

(72) Inventor: Matthew Keen, Brighton (AU)

(21) Appl. No.: 16/685,314

(22) Filed: Nov. 15, 2019

Related U.S. Application Data
(63) Continuation of application No. PCT/AU2018/050466, filed on May 17, 2018.

(30) Foreign Application Priority Data
May 17, 2017 (AU) 2017901864

(51) Int. Cl. B62D 33/033; B62D 25/20; B62D 27/06; B62D 29/00; B62D 29/04; B62D 65/02

(52) U.S. Cl. CPC B62D 33/033; B62D 25/2054; B62D 65/024; B62D 29/007; B62D 29/04; B62D 27/06

(57) ABSTRACT

A corner (100) suitable for placement between first (202) and second (204) orthogonal elongate deck sides of a deck (200), including a connecting frame (104) having a first connecting side (116) and a second connecting side (118) orthogonal to each other, the first connecting side configured to connect at or near an end of the first deck side and the second connecting side configured to connect at or near an end of the second deck side; and, a removable corner cover (102) adapted to connect to one or more of the connecting frame and the first and second deck sides.

### CROSS-REFERENCE TO RELATED APPLICATIONS

Continuation of International Application No. PCT/AU2018/050466 filed on May 17, 2018. Priority is claimed from Australian application no. 2017901864 filed on May 17, 2017. Both the foregoing applications are incorporated herein by reference.

### BACKGROUND

The present invention relates to decks. The invention may be useful for decks and/or tray decks for vehicles, and particularly useful for decks and tray decks for utility type vehicles.

Utility vehicles, sometimes referred to as utes, pick-ups or pick-up trucks, typically are equipped with a tray or tray deck at the rear of the vehicle, which serves to carry loads of various types. The loads may include equipment, sand, gravel and various other kinds of items and materials.

Some utility vehicles have a flat area, which may be referred to as a tray, a cargo bed or a deck. Other utility vehicles have a flat area which is surrounded by up to four sides to form a container, which may also be referred to variously as a tray or a cargo bed. The sides may be fixed or moveable, and may be a combination of fixed and moveable sides. Sometimes the side at the back is referred to as a tail gate.

In this specification, for consistency and ease of understanding, the vehicle will be referred to as a utility or utility vehicle; the flat area will be referred to as a deck; each of the sides will be referred to as side gates (front, rear, left and right); and the deck and side gates together (whether there be one, two, three or four side gates) will be referred to as a tray deck.

In some utility vehicles, the sides of the tray deck are fixed in position, the deck and sides forming what is sometimes referred to as a tub. In other utility vehicles, one or more of the sides are moveable between open and closed configurations. In this specification, unless otherwise indicated, the term side gate will refer to a side of a tray deck, wherein the side gate is moveable at least between open and closed positions. Some utility vehicles have side gates which are detachable. Typically, if a utility vehicle tray deck has a front side (usually adjacent a cab of the utility vehicle), the front side is in a fixed position, and in this specification the front side may be referred to as a fixed side or also referred to as a side gate, though it will be understood that the front side is typically in a fixed position.

Typically, a deck or tray deck will be provided with a utility vehicle when sold to a customer. The type of tray deck is either dictated by the model of the vehicle or there may be a very limited range of options available from which a customer can select.

It is also possible to buy utility vehicles without a deck or tray deck fitted, and the customer can select a deck or tray deck for their vehicle after purchase, but the customer will have a very limited range of options for a deck or tray deck.

Further, decks and tray decks are typically manufactured or supplied as a single unit, and can be fitted only to one vehicle model or a very limited range of vehicle models. Such units are bulky, which causes them to be inconvenient and expensive to transport, for example, form a place of manufacture to a place where the deck or tray deck is to be fitted to a utility vehicle.

Many decks and tray decks are not configurable or may have very limited options for configuration. A customer may want to include various features to make a deck or tray deck more suitable for that customer's intended use of the utility vehicle.

Another issue is that the corners of decks may be subject to a larger number of collisions than other parts of, for example, a utility vehicle on which the deck is located. If the corner is integrated with the deck, then the whole deck may require replacement if the corner is damaged. This can be expensive and inconvenient.

Further, deck corners may only serve a structural and aesthetic purpose, this may result in a wasted opportunity to employ the deck corner for functional purposes other than just being a corner of a deck.

It is an object of the present invention to overcome, or at least ameliorate, at least one of the above-mentioned problems in the prior art, and/or to overcome, or at least ameliorate, at least one problem in the prior art, which has not been mentioned above and/or to provide at least a useful alternative to prior art devices, systems and/or methods.

### SUMMARY OF THE INVENTION

In one aspect, the present invention provides a corner suitable for placement between first and second orthogonal elongate deck sides of a deck, including:
a connecting frame having a first connecting side and a second connecting side orthogonal to each other, the first connecting side configured to connect at or near an end of the first deck side and the second connecting side configured to connect at or near an end of the second deck side; and,
a removable corner cover adapted to connect to one or more of the connecting frame and the first and second deck sides.

In another aspect, the present invention provides a corner system for a deck, including:
first and second elongate deck sides;
a connecting frame having a first connecting side and a second connecting side orthogonal to each other, the first connecting side configured to connect at or near an end of the first deck side and the second connecting side configured to connect at or near an end of the second deck side; and,
a removable corner cover adapted to connect to one or more of the connecting frame and the first and second deck sides.

In another aspect, the present invention provides a method of joining first and second elongate deck sides of a deck, including:
connecting a first connecting side of a connecting frame at or near an end of the first deck side;
connecting a second connecting side of the connecting frame at or near an end of the second deck side;
wherein the deck sides, when both connected to the connecting frame, are orthogonal to each other; and,
connecting a removable corner cover to one or more of the connecting frame and the first and second deck sides.

### SUMMARY OF SOME OPTIONAL EMBODIMENTS OF THE INVENTION

In some embodiments, the connecting frame includes a tubular hole for receiving an elongate member having same or similar cross-sectional shape as the tubular hole. In embodiments, the tubular hole has a substantially square cross-sectional shape. In various embodiments, the tubular hole has an axis orthogonal to the elongate first and second deck sides when they are connected with the connecting frame. In various embodiments, the axis of the tubular hole is orthogonal to the deck when the corner is attached thereto.

In embodiments, the corner cover includes a plurality of protruding lugs for connecting the corner cover to the elongate first and second deck sides. A deck side may also be referred to as a coaming, or by other names. In other embodiments, the cover is shaped to complement the cross-sectional profile of the elongate first and second deck sides, and shaped to present an exterior corner profile between the elongate first and second deck sides.

In some embodiments, the connecting frame is formed from a stiff and resilient material, such as metal, so as to provide adequate stiffness between each of the elongate first and second deck sides. In embodiments, with a tubular hole, the connecting fame may be sufficiently stiff and resilient to provide a desired force on the elongate member when slid into the tubular hole.

In other embodiments, the corner cover is formed from a flexible material such as plastic. The plastic can be configured to provide sufficiently flexibility to deform and reform in the case of there being an unintended collision between the corner (as would be installed, for example, on a utility vehicle) and other objects. Typically, this feature will have best effect where the corner cover is the first point of contact in such a collision. In this way, the corner cover can be replaced if damaged, whilst other parts of the utility vehicle may survive undamaged.

In other embodiments, the frame includes a sleeve forming a hole in the corner, such that, when the corner is in use and connecting orthogonal deck sides, the axis of the hole is substantially vertical. The hole formed by the sleeve may have a square cross-sectional shape to accommodate an elongate object with a complementary square cross-sectional shape. In this regard, it will be appreciated that the corner is able to perform at least one function other than the structural and aesthetic functions of prior art deck corners.

In yet other embodiments, the corner cover may include a protruding member which forms a stopper for the hole formed by the sleeve when the corner cover is connected to the corner connecting frame. In embodiments, when the corner cover is attached to the corner, the stopper protrudes through an opening in a side of the tubular hole.

In example applications for various embodiments, the corner can be used for supporting an elongate member or side gate securing apparatus, which provides additional support for one or more side gates by connection at or towards a top of the elongate member (or at or towards the top of the side gate securing apparatus). The corner may also be used for supporting other devices and apparatus, such as canopy structural components, for example, frame members. The tubular hole may have many applications other than those mentioned in this specification.

### BRIEF DESCRIPTION OF THE DRAWINGS

At least one embodiment of the invention will be described with reference to the following, non-limiting illustrations representing the at least one embodiment of the present invention, in which:

FIG. 1 is a rear perspective view of a utility vehicle deck in accordance with an embodiment of the present invention;

FIG. 2 is a detailed rear perspective view from FIG. 1 showing a deck corner apparatus and deck corner system in use with a deck for a utility vehicle in accordance with an embodiment of the present invention;

FIG. 3 is an exploded view of FIG. 2 showing components of the deck corner apparatus and the deck corner system in accordance with an embodiment of the present invention;

FIG. 4 is an exploded view of the deck corner apparatus with an elongate member that can be slid into the hole in the deck corner as an example application in accordance with an embodiment of the present invention;

FIG. 5 is a side elevation view of the deck corner apparatus with an elongate member slid into the hole in the deck corner as an example application in accordance with an embodiment of the present invention; and,

FIG. 6 is a reverse angle view of the deck corner and elongate member as an example application as depicted in FIG. 5.

### DETAILED DESCRIPTION OF SOME EMBODIMENTS

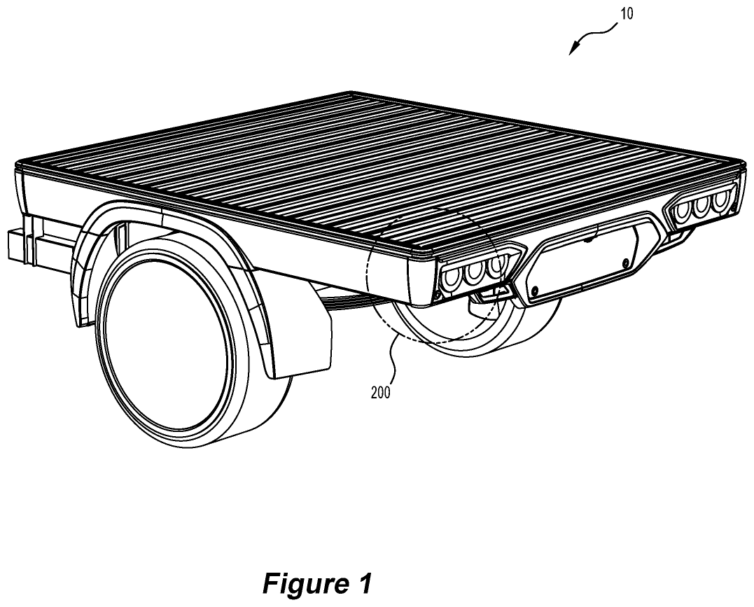

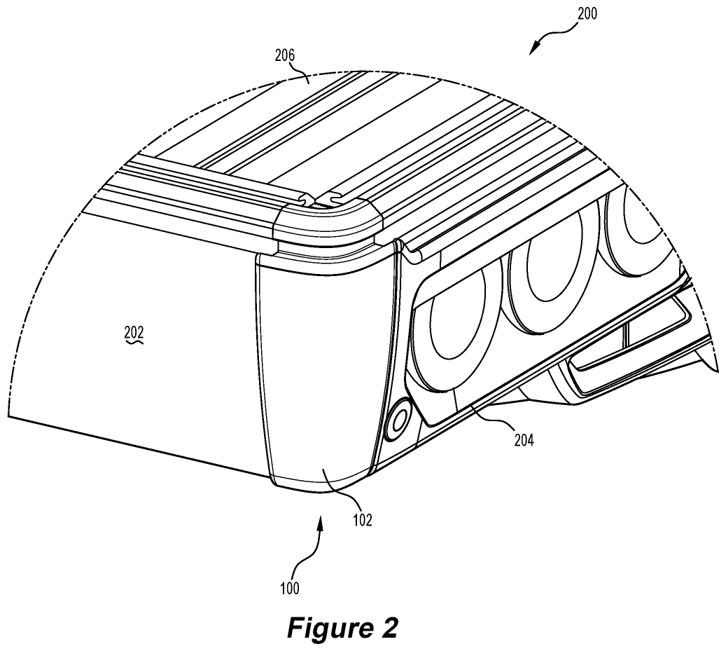

FIG. 1 shows a rear perspective view of the rear of a utility vehicle 10 with a deck. A part of the deck 200 incorporating a corner is shown in detail in circle (drawn with long and short dashes) indicating features detailed in FIG. 2.

In FIG. 2 there is shown a detailed view of a corner of the deck 200 (as shown in FIG. 1) with a deck top 206 and elongate deck sides, including the left deck side 202 and the rear deck side 204. The rear deck side includes a lighting module for a utility vehicle. The deck sides are orthogonal to each other, and a deck corner 100 is positioned between the deck sides.

In FIG. 2 the only part of the deck corner 100 that can be seen is the corner cover 102. This is sometimes referred to as a shroud. The corner cover is formed to complement the outer profile shape of the deck sides 202 and 204 to provide a pleasing aesthetic effect.

In one embodiment, the corner cover can be shaped to form a stopper for channels in the deck sides, so that, when fitted, the corner cover stops items in the channels from sliding out of those channels. In some embodiments, the corner cover can be securely fitted so that the items in the channels are also secure and cannot be readily taken out by someone without authorisation.

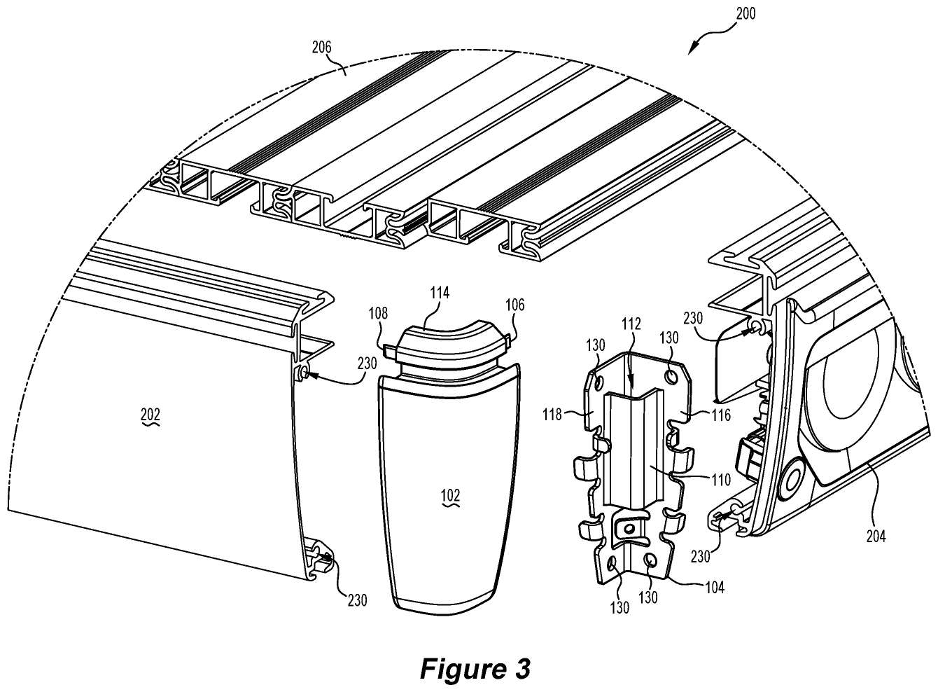

FIG. 3 shows components of this embodiment of the deck corner 100, including the corner cover 102 and the deck corner connecting frame 104. The connecting fame has a first connecting side 116 and a second connecting side 118, wherein the connecting sides are orthogonal to each other. The first connecting side, in use, connects with the rear deck side 204, and the second connecting side, in use, connects with the left deck side 202. The connecting sides 116 and 118 each have a plurality of holes 130 through which screws, lugs, rivets or other connecting devices are placed to join into respective holes 230 in the deck sides, thus securing the connecting frame to the deck sides.

In an example method, the connecting frame 104 is connected with lugs to both the left deck side 202 and the rear deck side 204, the deck 200 is then assembled with the deck top 206 being placed into a deck surround created by connecting a number of the deck sides and deck corners. After the connecting frame is connected to the deck sides, the corner cover 102 can be connected to the deck sides 202 and 204 to complete the deck corner installation. The corner cover includes a first tab 106 to engage with the rear deck side 204 and a second tab 108 to engage with the left deck side 202, in this way the first and second tabs 106 and 108 assist in holding the corner cover in place in the assembled deck corner and deck sides by using a friction fit provided by the tabs.

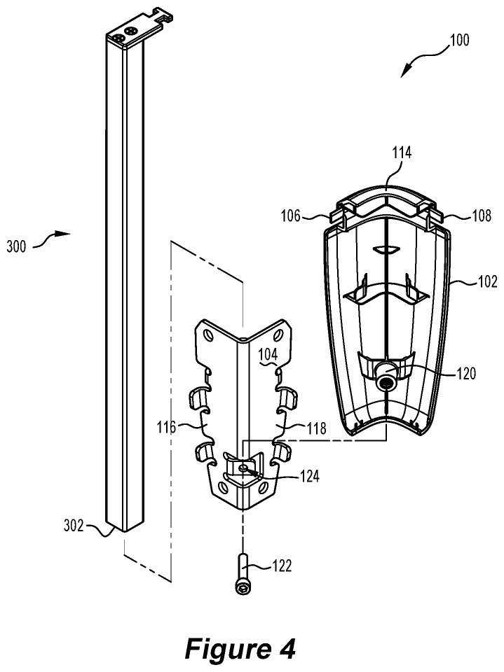

The connecting frame includes a sleeve 110, which forms a tubular hole 112 in the connecting frame. In this particular embodiment, the tubular hole has a square shaped cross-section, however, it will be understood that the cross-section could have other shapes, including a circular shape. The tubular hole is of square cross-sectional shape to accommodate an elongate object of complementary square cross-sectional shape. The corner cover 102 has a section 114 at or towards the top thereof with two orthogonal edges (see FIG. 4) which contribute to forming a square opening when the corner cover is connected to the connecting frame. The square opening allows access to the tubular hole 112 when the corner cover is connected and in use. It will be understood that the opening could be other than square shaped and can be selected to match the cross-sectional shape of the tubular hole 112.

FIG. 4 shows an example use of the deck corner 100 for holding an elongate member 300. The elongate member has a bottom end 302, which slides into the tubular hole 112 (not shown in FIG. 4) of the deck corner 100. As shown in FIG. 4, the corner cover includes a cylindrical protrusion 120, so that, when the corner cover is connected, the cylindrical protrusion forms a stopper beneath the tubular hole 112 created by the sleeve 110 (also, not shown in FIG. 4) and the connecting frame 104. In this embodiment, the corner cover is further secured to the connecting frame by a screw, which slots through an opening 124 in a part of the connecting frame and screws into a hole along the central axis of the cylindrical protrusion 120. When the elongate member 300 is slid into the tubular hole 112, the stopper 120 ensures the member does not slide further than the position of the stopper.

The tubular hole 112 in the deck corner 100 may be used for holding other types elongate members, for example, an elongate member may be (or may form part of) a leg-post for a frame supporting a tarpaulin to cover the deck of a utility vehicle. A tarpaulin supporting frame may have two elongate members forming legs of the frame, wherein each leg is configured to slide into the tubular hole of respective left- and right-side deck corners.

The deck corner 100 may also be used for holding other equipment such as a light, a siren light or a speaker on a pole, the pole configured to slide into the tubular hole. In other example uses, the tubular hole may be configured so as to be suitable for accepting the handle of a fishing rod to be inserted therein.

In other embodiments, the tubular hole 112 of the deck corner 100 is of circular shaped cross-section and is provided with a thread, so that equipment with a complementary thread can be fitted therein by screwing. Such an arrangement provides a more secure hold for the equipment fitted into the tubular hole. Example equipment includes securing means, such as hooks or eyelets, with a threaded section depending from the securing means for screwing into the threaded tubular hole. Such securing means can be used as anchoring points for ropes or tie-downs or the like.

There are many uses for a deck corner incorporating such a tubular hole, and the above examples should not be construed as limiting.

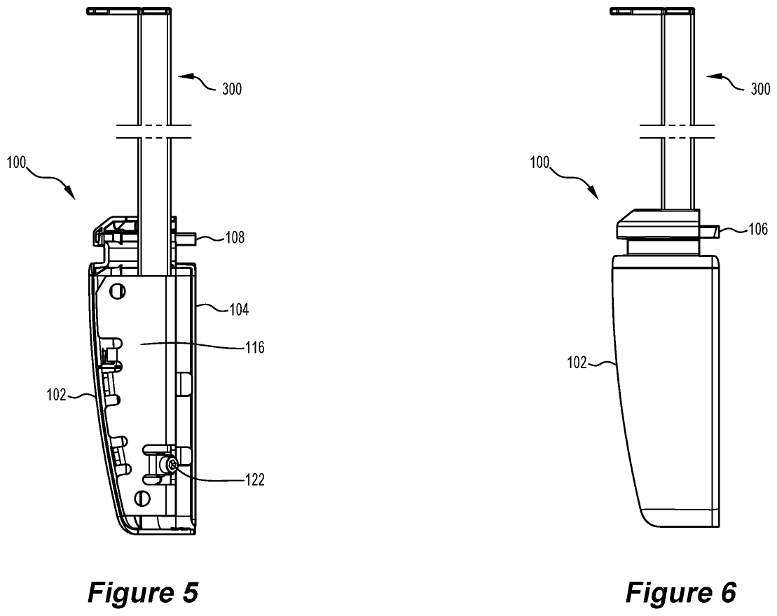

FIGS. 5 and 6 show views from different angles of the assembled connecting frame 104 and corner cover 102, with the elongate member 300 inserted in to the deck corner tubular hole 112.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not and should not be taken as an acknowledgement or any form of suggestion that the prior art forms part of the common general knowledge.

US claims:

1. A corner suitable for placement between first and second orthogonal elongate deck sides of a deck, comprising:
a connecting frame having a first connecting side and a second connecting side orthogonal to each other, the first connecting side configured to connect at or near an end of the first deck side and the second connecting side configured to connect at or near an end of the second deck side; and,
a removable corner cover adapted to connect to one or more of the connecting frame and the first and second deck sides.

2. A corner according to claim 1, wherein the connecting frame comprises a tubular hole for receiving an elongate member having same or similar cross-sectional shape as the tubular hole.

3. A corner according to claim 2, wherein the tubular hole has an axis orthogonal to the elongate first and second deck sides when the elongate first and second deck sides are connected with the connecting frame.

4. A corner according to claim 2, wherein the axis of the tubular hole is orthogonal to the deck when the corner is attached thereto.

5. A corner according to claim 2, wherein the connecting frame comprises a sleeve forming the tubular hole in the corner.

6. A corner according to claim 2, wherein the corner cover comprises a protruding member which forms a stopper for the tubular hole when the corner cover is connected to the corner connecting frame, the stopper for stopping an elongate member when placed in the tubular hole.

7. A corner according to claim 6, wherein, when the corner cover is attached to the corner, the stopper protrudes through an opening in a side of the tubular hole.

8. A corner according to claim 1, wherein the corner cover is shaped to complement the cross-sectional profile of the elongate first and second deck sides, and shaped to present an exterior corner profile between the elongate first and second deck sides.

9. A corner according to claim 1, wherein the corner cover comprises a plurality of protruding lugs for connecting the corner cover to the elongate first and second deck sides.

10. A corner according to claim 1, wherein the connecting frame is formed from a stiff and resilient material, such as metal.

11. A corner according to claim 1, wherein the corner cover is formed from a flexible material such as plastic.

12. A corner according to claim 11, wherein plastic is configured to provide sufficiently flexibility to deform and reform where there is a collision between the corner and other objects.

13. A corner according to claim 2, wherein the elongate member forms part of a side gate securing apparatus for providing additional support for one or more side gates by connection at or towards a top of the side gate securing apparatus.

14. A corner according to claim 2, wherein the elongate member forms part of a leg-post for a frame supporting a tarpaulin to cover the deck of a utility vehicle.

15. A method of joining first and second elongate deck sides of a deck, comprising:
connecting a first connecting side of a connecting frame at or near an end of the first deck side;
connecting a second connecting side of the connecting frame at or near an end of the second deck side;
wherein the deck sides, when both connected to the connecting frame, are orthogonal to each other; and,
connecting a removable corner cover to one or more of the connecting frame and the first and second deck sides.

16. A method according to claim 15, wherein the connecting frame comprises a tubular hole for receiving an elongate member having same or similar cross-sectional shape as the tubular hole, the method comprising placing the elongate member in the tubular hole.

17. A corner system for a deck, comprising first and second elongate deck sides and the corner of claim 1.
